(19) United States
(12) Patent Application Publication
(10) Pub. No.: US 2014/0103158 A1
(43) Pub. Date: Apr. 17, 2014

(54) AirShip Endurance VTOL UAV and Solar Turbine Clean Tech Propulsion

(71) Applicant: Benjamin Lawrence Berry, Lake Oswego, OR (US)

(72) Inventor: Benjamin Lawrence Berry, Lake Oswego, OR (US)

(21) Appl. No.: 13/650,508

(22) Filed: Oct. 12, 2012

(51) Int. Cl. B64C 29/00; B60F 5/02

(52) U.S. Cl. CPC B64C 29/0016; B60F 5/02
USPC 244/2; 244/12.1

(57) ABSTRACT

An aircraft with a wide fuselage having a longitudinal axis, a left and right forward swept wing mounted well back on the fuselage, a tail section extending from the aft portion of the fuselage, a first and second brushless ducted fan with air accelerator ring stationary and integrated into the left and right lateral fuselage, a third brushless ducted fan with integrated air accelerator ring rotatable mounted to the aft tail portion, a solar turbine based external solar film applied on the fuselage and wing surfaces and lateral fan regenerative drive that powers all ducted electric fans, that powers one internal-mounted central master impeller motor, that powers a brushless electric motor that spins three supercharger impellers via pulley chains to enable all three air accelerator rings with super compressed forced air thrust, that recharges ultracapacitors for aircraft propulsion of persistent flight endurance targeted for 30 to 90 days.

### TECHNICAL FIELD AND INDUSTRIAL APPLICABILITY OF THE INVENTION

This invention relates generally to a small Vertical Take-Off and Landing (VTOL) aircraft with fixed forward swept wings mounted well back on the fuselage and uniquely designed fuselage-embedded ducted fans and rotatable aft ducted fan with integrated Solar Turbine enabled air accelerator propulsion rings, which can be utilized as an Unmanned Aerial Vehicle (UAV).

### BACKGROUND

The 2012 Defense Appropriations—Federal Aviation Administration (FAA) law change opens the USA national airspace to unmanned aerial vehicle (UAVs) that weigh up to 25 pounds that can fly up to a 400 foot altitude ceiling, and serve 1^{st} Responder customers for intelligence, surveillance and reconnaissance (ISR). The need is for small, light weight UAVs that can execute the flight mission, that do not use runways or hand launchers, have the ability to conserve power for long flight endurance, make use of a clean technology that is sustainable with a solar turbine to eliminate the weight of traditional onboard fuel, and that can operate in stealth (with reduced sight and noise distractions). The AirShip Endurance VTOL UAV aircraft is designed to deliver all of this and operate as a dual-use aircraft for both the commercial and defense markets.

### SUMMARY

Continued UAV miniaturization is resulting in a migration of capability from larger to smaller platforms. For instance, the sensor capabilities first demonstrated on the RQ-1A Predator in 1994 are now available on the RQ-7 Shadow. Moore's Law “like” evolution will continue to push more capability to smaller and smaller platforms as progress is made through the next two decades. Small UAVs have the potential to solve a wide-variety of difficult problems that may be unaffordable by trying to find solutions with traditionally larger platforms.

The configuration of the AirShip Endurance VTOL UAV was developed as a result of design requirements of flight-mission and multi-functional application specifications, performance opportunities and constraints, and propulsion demands. This UAV aircraft is configured to provide a substantial real-time remote control field of view for intelligence, surveillance and reconnaissance (ISR); a multi-application/functionality payload capacity including air filter sniffing; and a flight and hover maneuvering capabilities that meet mission specifications.

The aircraft fits identified aircraft design and control strategies necessary to achieve a VTOL UAV (pilotless) hover capability mainly used during launch, fixed ISR stare maneuvers, and land operations. The aircraft highlights design trade-offs that yield the capability of a fixed wing UAV (in terms of endurance and payload) while allowing for vertical take-off and landings for various mission applications.

Based on the AirShip Endurance VTOL UAV being a twin-lateral and aft ducted compressed forced air accelerator aircraft, there are no comparative light weight, long endurance UAVs in any of the ultralight or small UAVs that compare to this propulsion system. The AirShip Endurance VTOL UAV is designed with high speed ducts driven by Solar Turbine clean tech propulsion. The ducted fans and integrated air accelerator rings accelerate the airstream and add momentum to the mass of air through the turbine sufficiently to provide for vertical lift capacity to lift the aircraft to the desired altitude. Compared to the efficiency of conventional non-ducted rotorcraft rotors, the aircraft's two lateral and aft ducted fan and air accelerators have greater efficiency in utilizing horsepower at the ducts in moving the mass of air required to provide the desired lift. The ducted fan with integrated air accelerators maximize the air mass flow without the loss of air at rotor tips experienced with conventional rotorcraft rotor blades. The extreme high velocity of the air through the ducts compensates for their short ducted fan disc diameter as compared to the diameter of conventional overhead helicopter rotors.

The propulsion systems, solar film array, regenerative drive ducted fans, rechargeable ultracapacitors, and landing gear are all positioned around, in, and underneath the UAV aircraft to achieve a desired static margin. The rationale for the AirShip Endurance VTOL UAV being a low aspect forward swept wing aircraft is to achieve a high field of view and to accommodate three combinations of ducted fans with integrated air accelerator rings.

Air flowing over any swept wing tends to move span wise towards the rearmost end of the wing. On a rearward-swept wing this is outwards towards the wing tip, while on the AirShip Endurance's forward-swept wings it is inwards towards the root. As a result, the dangerous tip stall condition of a backwards-swept design becomes a safer and more controllable root stall on the AirShip Endurances forward swept design. This allows full aileron control despite loss of lift, and also means that drag-inducing leading edge slots or other devices are not required.

With the air flowing inwards, wingtip vortices and the accompanying drag are reduced, instead the fuselage acts as a very large wing fence and, since the AirShip Endurance's wings are larger at the root, this improves lift allowing for a low aspect smaller wing. As a result maneuverability is improved, especially at high angles of attack. At transonic speeds, shockwaves build up first at the root rather than the tip, again helping to ensure effective aileron control.

A VTOL Aircraft for the Commercial Market

The present disclosure is directed to an aircraft that contemplates no need for a runway, roadway or launcher system. The capabilities and properties of this aircraft make it compact and versatile so as to enable the commercial market 1^{st} Responders (Law Enforcement, Fire Departments, Emergency Medical, Search and Rescue, DOTs , homeland security, the news media, etc.) to maneuver the aircraft as an aerial service delivery platform for intelligence, surveillance and reconnaissance (ISR). For example, the aircraft can be flown by a person with a line of sight radio controller and using a smart phone, can watch aerial geo-spatial video-on-demand images from cameras on board the UAV. The UAV aircraft can lift off from any platform, road, building top, truck, ship, and even within large scale buildings such as sports arenas where people congregate. The invention provides a versatile VTOL aircraft that is small, lightweight and powerful enough to takeoff quickly from land or water surface, fly at a high rate of speed for a small VTOL (60 miles per hour). With its Solar Turbine propulsion it maintains persistent flight endurance of 30 to 90 days, depending on weather conditions.

Alternatively for autonomous flight control strategies, AirShip Endurance VTOL UAV uses controls that are targeted for complete autonomous flight. Given multiple mission pre-programmed flight instructions, the UAV will be able to launch and land even in the presence of loss of communication. As the UAV is to launch and land in a small, possibly confined space, often near humans, safety and failure modes are well characterized. The aircraft will fly autonomously under directions of GPS to its destination.

The UAV aircraft is dual-use technology that can serve as a UAV from a soldier's backpack. One of the reasons the aircraft has forward swept wings is for the wing to be folded at the mid-section on to itself for a smaller physical footprint. By folding the flexible outer wings, the UAV can be transported as a smaller aircraft and launched in seconds for soldiers to have ISR over the next hill, around buildings or for monitoring the outer perimeters of forward operating bases, etc.

The UAV aircraft invention uses a Solar Turbine Clean Tech Propulsion system that comprises solar film on the exterior of the entire aircraft and lateral regenerative ducted fans with rechargeable ultracapacitors for electricity storage and reuse. During daylight hours, the aircraft flies on solar power, uses regenerative drive lateral ducted fans during forward flight, and stores excess electrical power in its onboard ultracapacitors. The ultracapacitors charge up very fast and dissipate electricity very slowly. During night flights, the UAV flies on its ultracapacitors-powered ducted fans with integrated air accelerators. Much energy is expended during VTOL operations, but in its forward flight operations, the AirShip Endurance VTOL UAV converts to regenerative electricity through the lateral ducted fans, moves the aft ducted fan from zero-degrees plane through +135-degree to −135-degrees range of motion plane. This operation dramatically reduces flight power management needs and allows the low aspect forward mounted fixed wings to lift the UAV during accelerated forward flight. The integrated air accelerator rings in each duct can be engaged solely during forward flight as needed to reduce even more energy consumption while forgoing the use of the aircraft's electric ducted fans.

In forward flight, the lateral ducted fans catch the wind and serve as integrated wind turbines as they channel wind through them creating electricity via regenerative wind power. To increase effective regenerative wind speed at the lateral turbines by a factor of at least 2 and possibly 4, the lateral ducted fan's leading edge is lower than the trailing edge and serves as a wide aerial air intake scoop during forward flight that rams the air through the ducted fan turbines. Both solar film and the airborne wind turbine regenerative drive serve to recharge the UAV's ultra-capacitors for long persistent flight endurance.

For clean technology, electronics prospered with silicon chips followed by printed integrated circuits (PIC). As industry sought better, faster, and less expensive electronics, industry ultimately developed PIC for every application. The AirShip Endurance VTOL UAV is making use of a pre-patented process and applying it to print electronics on thin films at extremely low cost with ultra high efficiencies, incorporating proprietary aerogels, the lightest solids in the world, into the process.

The UAV achieves power from the external solar film and aerial regenerative drive that delivers power to ultracapacitors to power a chamber-enclosed electric master impeller motor. The master impeller motor sucks in outside air, compresses that air by spinning inside the chamber and ports the compressed air through a series of narrowing major and minor air shafts that lead to each of the narrowed shaft air accelerator rings integrated in the inner ring lining of the all three duct fans. The master impeller motor spins at 4,000 RPM while each of three micro supercharger impellers spin at 50,000 to 65,000 RPM. This intensifies the compressed air thrust at each ducted fan and integrated air accelerator.

The electric ducted fans with their integrated air accelerators, the master impeller motor and micro supercharger impellers are powered by the external solar film, aerial regenerative drive lateral ducted fans and rechargeable ultracapacitors. The lateral ducted fans are counter rotating fans to keep the UAV flight direction stable.

### Master Impeller Motor and Ducted Fan Architecture

The UAV's master impeller drives all three ducted fan integrated air accelerators during VTOL and forward flight operations. By not using the ducted fan, the UAV can use its integrated air accelerators in each duct with muted sound acoustics and in this mode is comparable to a stealth operations model. The structure for the lateral ducted fans are embedded stationary from aerial through anterior of the aircraft's fuselage. This ducted fan molded fuselage architecture allows for less weight as there is no separate ducting apparatus to house the ducted fan with its integrated air accelerator ring. This offsets the additional weight of the master impeller motor and three micro impeller motors. The aft ducted fan is a design that allows for rotatable ducted fan thrust controlling attitude, flight direction, and forward flight. The two lateral counter-rotating ducted fans are strong enough to raise the UAV during vertical take-off and hold the UAV stable during the aft ducted fan transition from positions of hover, backing up or and yaw movement right to left with the rudders attached to the aft ducted fan.

The lateral ducted fans are placed just forward of the aircraft center of gravity (CG). The air accelerator narrowing major and minor air shafts connect to the lateral duct air accelerator rings just below mounted ducted fans. The aft ducted fan is mounted on a cross mount that is located above the aft ducted fan and serves as a swivel arm to move the ducted fan from 0-degrees through +135-degree to −135-degrees range of motion. Connected to the aft duct housing are two rudders mounted just inside the ducted fan and protruding half way beyond the edge of the duct. These rudders allow for the UAV's yaw left and right controls. The lateral ducted fans are mounted far enough forward of the low aspect rings and the upper portion of these ducts is designed to allow for a scoop effect that directs and ramjets air at a high rate of speed down the top of the duct. This supports the air flow aerodynamics.

The rear or aft ducted fan is mounted as a swivel through the high mounted control arm and is manipulated by control arm fly-by-wire servo motors. The aft ducted fan is slightly elevated above the center line of the fuselage embedded lateral ducted fans. Since the master impeller motor is located inside the center of the fuselage rather than outside in the ducted fans, a better in line center of gravity is established resulting in quicker response, better balance and increased stability in flight and/or hover.

### Ducted Fans

Using an electric master impeller, three micro supercharger impellers, and three electric ducted fans, the AirShip Endurance VTOL UAV is propelled while both low aspect forward swept wings are fixed. At launch, there is no need for the lateral ducted fans to pivot in order to control direction during VTOL to fixed wing flight. At launch, the lateral ducted fans deliver thrust to gently advance the aircraft forward during aft ducted fan transition from horizontal zero-degrees through +135-degrees up to −135-degrees down range of motion. The thrust produces lift and balance from the two lateral ducted fans with integrated air accelerator rings. As the two laterals and one aft ducted fan engage, the aircraft begins to move and transitions into forward motion that culminates into full fixed-wing forward flight characteristics. Once forward flight is achieved, the lateral ducted fan's electrical power is reduced and the aft ducted fan and electric power fully engages to maintain flight and is aided by the lift of the UAV's forward mounted wings. This approach conserves energy.

Because the master impeller motor and three micro impeller motors are fuselage centrally mounted, and not outboard of the fuselage, this reduces weight on the side of the fuselage and/or wing tips. It thereby uses less power and torque and in turn making the aircraft more responsive and stable.

To prevent the lateral ducted fans from pushing air out the front of the duct at higher speeds, the fuselage embodied ducted fans are designed with the slope of the aircraft fuselage, thereby making use of a designed-in air scoop effect that ramjets air through the top of the aircraft. This lifting air intake duct design creates low pressure in the bottom front of the duct which helps eliminate the need for more wing area and in turn reduces the weight of the aircraft.

By integrating accelerator rings with the ducted fans, power to the mounted ducted fans can be dialed down while the air accelerator rings our powered up. This results in net reduction of the noise created by the turning ducted fans. This architecture supports the UAV as a stealth design that will also help reduce or eliminate a radar signature because the ducted fans are contained within or inline with the fuselage.

All three ducted fans with integrated air accelerators are aerodynamically designed for sufficient ground clearance. The fixed lateral ducted fans are powerful enough that they permit the aircraft to take off and land in the VTOL mode even with operational loss of the aft ducted fan. Conventional runway, road take-off and landing, or independent launcher is not needed to launch or land the aircraft. The aircraft's VTOL capabilities are made possible because the ducted fans are embedded with the left and right fuselage with the fan blades mounted in the ducts. However, the lateral ducted fan cannot be rotated, unlike the aft ducted fan.

### Airborne Wind Turbine Regenerative Drive

After power for the active lateral ducted fans are shut off for forward flight, the lateral fans serve as integrated wind turbines to channel wind through them creating electricity via regenerative wind power. To increase effective wind speed at the lateral turbines by a factor of at least 2 and possibly 4, the lateral ducted fan's leading edge is lower than the trailing edge and serves as a wide aerial air intake scoop during forward flight that rams the air through the ducted fan turbines. With this design, there are no uneven wind speed patterns to the passive spinning lateral blades, which would cause noise or blade fatigue. The in-fuselage scoop design serves as a practical protective surface, to safeguard people from possible blade disintegration, keeps birds away from the spinning blades, and protects the turbine from weather and sun damage.

The constant and steady wind created by forward flight forces the lateral ducted fan turbines to generate constant passive electricity. Since the winds are directed to the lateral ducted fans through the aerial in-take scoops, the lateral ducted fan turbines are always positioned at a 45 to 90-degree angle from the horizontal winds, thus catching winds while permitting the low aspect wings to generate lift. This passive regenerative drive power production feeds electricity to the ultracapacitors, which turns the lateral ducted fans into electric generator motors during forward flight. Once flight management demands VTOL flight, the lateral ducted fans quickly return to active electric ducted fan operation and/or integrated air accelerator compressed air propulsion.

Doubling wind speed in the active aft turbine can increase lateral ducted fan passive regenerative wind turbine output power by 8×. Thus combining clean tech wind turbine power with the solar film power to optimally charge the UAV's ultracapacitors for persistent flight endurance. The passive regenerative wind power is activated through much of the UAV's flight during night or day, where as the solar film is active only during daylight hours.

### Lifting Body Airframe.

The AirShip Endurance VTOL UAV aircraft body is aerodynamically designed as a wide angle lifting body. With a front and narrow angle of attack, this design lends itself to a lifting body application. The material for the AirShip Endurance fuselage airframe is made of carbon fiber that is lightweight and durable. A crucial aspect of the manufacturing plan was to first identify the areas where weight could be removed that has no function. Currently for the FAA's US national air space UAV rule requirements, the total weight of the UAV can be no more than 25 pounds. Most of the AirShip Endurance's applications will require varying payloads of low weight and sensitive electronic components; therefore, getting the overall aircraft weight far below the 25 pound limit while maintaining maximum frame integrity best meets the AirShip Endurance VTOL UAV systems requirements.

The exterior aerodynamic fuselage, low aspect forward swept wings, the aft V-Wing and anterior fuselage are constructed from a carbon fiber substrate. The overall airframe is impervious to rust and corrosion and also staunchly resistant to dings and dents. Expectations are for the aircraft's exterior to hold up against corrosion for an estimated 25 years. The aircraft's aerodynamic front-end, flexible outer fuselage are designed and manufactured to absorb light impacts. The AirShip Endurance's basic structure is formed from a combination of tooling that is stamped, extruded and cast with carbon fiber. It has targeted connection points bonded by high-strength adhesives.

The aerodynamic shape of the lateral ducted fans with integrated air accelerator rings provide for more lift and less weight when coupled with the aircraft's low aspect forward swept wings. The aircraft does not use exposed rotors, and the UAV is able to operate safely with human operators in close proximity because the ducted fan rotor assemblies are enclosed.

### Fly-By-Wire Control System

The current invention incorporates a computer controlled fly-by-wire system which calculates gyroscopic stability and sends information to one or more ducted fans with integrated air accelerator rings to adjust them to the correct pitch for controlled flight. The AirShip Endurance VTOL UAV rate gyro serves as a dampener—it dampens the amount of yaw movement to the AirShip Endurance from any source. These sources include torque variation from ducted fan speed, pitch, and cyclic are adjusted, a gust of wind blowing the tail around (weathervane effect) or by a command from the transmitter of a radio controlled operator or autonomous flight management system.

### Low Aspect Forward Swept Fixed Wing

The AirShip Endurance VTOL UAV employs a wide aerodynamic high lift/drag ratio fuselage with lateral integrated low-aspect forward swept fixed wings set mid-range to aft on the aircraft's mid-section. A horizontal empennage wing, with a slight pitch angled aft V-Tail, serves as an angled tail section with two in-set tails set to a 45-degree position. Together, the two tail winglets of the V-Tail serve as stabilizers while the aircraft is in flight. Two lateral ducted fans with integrated air accelerator rings are on either side of the aircraft and an aft ducted fan with integrated air accelerator ring helps support this efficient configuration while ensuring aircraft stability. By combining the attributes of a fixed wing airplane and a helicopter to a lightweight and compact UAV aircraft, the fixed wing configuration enables the aircraft's lift to fly persistent flight endurance with long loitering flights that glide on the air. Therefore, the aircraft is not solely depended on ducted fans for lift.

The UAV's empennage wing sizing and location is based on the AirShip Endurance's longitudinal and directional stability criteria. Twin vertical tails are placed on the outboard section of the horizontal tail, in line with the aft ducted fan thrust line. This is done for two reasons: to add weight to the outboard section of the horizontal tail, reducing the flexing that will occur under high load conditions, and to minimize the side force on the vertical tails due to ducted fan with integrated air accelerator ring slipstream.

A low aspect forward swept fixed wing arrangement on the fuselage was selected for its favorable low profile characteristics. This configuration supports wide coverage of the renewable energy solar film to maximize energy production to fuel the UAV. Based on the equivalent platform area, the wing has a forward-swept wing design that produces a 15 percent better ratio of lift to drag in the transonic speed region. The quarter-chord sweep is a consequence of the wing taper. This forward swept configuration is used because this wing type is highly maneuverable at transonic speeds and because air flows over a forward-swept wing and toward the fuselage, rather than away from it. The reverse airflow on the wing flows inward from the wing tip toward the root of the wing does not allow the wing tips and their ailerons to stall at high angles of attack. Rather than having a vertical tail and stabilizer the AirShip Endurance uses a V-tail configuration for added maneuverability. The UAV aircraft does not exceed the subsonic barrier but uses the forward swept configuration in conjunction with a variable chord wing which adapts to the VTOL flight characteristics of the craft from lift off to cruise speed. Optionally, a central chord air bladder eliminates the need for physical ailerons thus reducing weight and simplifying the wing design. The AirShip Endurance uses the Grumman K airfoil which has an average aileron chord of 0.3499 of the wing chord.

The wing has a wing sweep angle of 40° because the high wing configuration alone is expected to provide sufficient lateral stability in unison with the V-tail stabilizers.

Grumman airfoil K was chosen for the AirShip Endurance VTOL UAV's wing because of its high lift capabilities when used with its VTOL operation. The variable wing chord will keep the AirShip Endurance stable while climbing out of an attack run.

The AirShip Endurance VTOL UAV's low aspect forward swept mounted wings and overall fuselage has four layers. The first layer is an outer surface that is a four-layer nanotechnology solar film printed over the second EMI (electromagnetic interference) layer.

Layers one and two are applied to the exterior of the aircraft's a carbon fiber substrate third layer. The fourth layer is a printed electronic circuitry layer that is embedded in the carbon fiber substrate. This process makes for an extremely light weight aircraft. Once all internal components are applied, the vehicle weight meets the FAA weight requirement for UAV flying in the US national air space.

This lightweight material and airframe are designed as a lifting body which helps reduce the weight and square footage area of the forward swept fixed wings. The design shares the best capabilities for vertical take-off, landing and flight capabilities of a helicopter and conventional use of fixed wing aircraft during forward flight. When the aircraft is in hover position, air deflectors mounted in the duct cowling of the aft ducted fan with integrated air accelerator enable the aircraft to move sideways and to counter rotate. By rotating the aft ducted fan in a horizontal plane, the UAV is able to move forward and backwards safely in tight spaces. The aircraft uses maximum power to transform into forward flight. Once airborne, the lateral ducted fans with integrated air accelerators are powered down and consume less energy as the aft ducted fan moves from a vertical downward pointing position (0-degree) to a horizontal (90-degrees) position. At this point, fixed wing flight operations allows for lift and persistent long endurance flight. With this approach, the AirShip Endurance VTOL UAV conserves energy consumption of its solar energy produced electricity.

### Landing Gear

The UAV landing gear allows the AirShip Endurance VTOL UAV, with full payload, to land on a space of square footage no bigger than the aircraft. Since the UAV is VTOL operated, no runway is required. For the landing gear, there are three dome bumpers used for protecting the AirShip Endurance undercarriage surface and equipment. The domes isolate the ducted fan with integrated air accelerator rings and anterior nose-mounted surveillance camera turret equipment from impact and vibrations during VTOL operations. The domes are medium-soft, non-marking polyurethane-rubber material with Durometer hardness of 70 Scale OO. There is a pressure-sensitive installation to the underbelly of the aircraft.

This cushioned design allows a softer landing to prevent fuselage and airframe damage while landing or taking off. The dome landing gear is designed to withstand a load that is more than enough to support the AirShip Endurance weight requirement. This will ensure structural integrity for a fully loaded aircraft landing. The dome gear will allow landings on hard surfaces, unpaved or soft fields, or water. For the AirShip Endurance V2 VTOL UAV, the dome is 2.2 inches in diameter and has a height of 1.0 inch. The dome gear has a 1.0 inch clearance from the ground surface. With this, the dome is also required to soften a high descent rate landing.

### Acoustic Impact

From both a commercial and military mission standpoint, detection of the noise from VTOL aircraft is a concern. Three major factors determine the distance at which aircraft can be aurally detected: (1) the spectrum and directivity of the noise produced by the aircraft, (2) the effect of the atmosphere and ground cover in attenuating this noise, and (3) the background noise present at the listener. The AirShip Endurance VTOL UAV has considered these factors in the design of the aircraft when absence of detection is important to the mission.

The aircraft's lateral ducted fans with integrated air accelerator rings use a fuselage in-plane noise reduction strategy. Lateral ducted fan noise levels are attenuated by the blades being recessed within the fuselage that partially cancels the negative pressure peak commonly associated with steady thickness noise. It is surmised that the “anti-noise” is generated from increasing ducted fan in-plane forces in the vicinity near the advancing blade side. The net increase in blade lift subsequently increases the in-plane force while achieving meaningful in-plane noise reduction. For this strategy, it yields a decrease in predicted noise detection distance and promotes source noise reductions.

The AirShip Endurance VTOL UAV's ducted fans with integrated air accelerator rings is a propulsion system whereby its rotor fans are mounted within a cylindrical shroud (duct). The duct reduces losses in thrust from the tip vortices of the fan, and by varying the cross-section of the duct allows the design to advantageously affect the velocity and pressure of the airflow. In the aircraft, its ducted fans have more and shorter blades than traditional rotors and thus can operate at higher rotational speeds. The operating speed of an unshrouded rotor is limited since tip speeds approach the sound barrier at lower speeds than an equivalent ducted fan. The aircraft's ducted fan assemblies use an odd number of blades (3) to prevent resonance in the duct. Eliminating the resonance prevents the tendency of the aircraft's rotor fans to oscillate with larger amplitude at some resonant frequencies than at others. The goal at these frequencies is to eliminate even small periodic driving forces that can produce large amplitude oscillations, because the system stores vibration energy.

The AirShip Endurance VTOL UAV aircraft pays attention to resonances occurring when the ducted fan and air accelerator rings are able to store and easily transfer energy between two different storage modes of kinetic energy. However, there are some losses from cycle to cycle, called damping. The aircraft keeps damping small, whereby the resonant frequency is approximately equal to a natural frequency of the ducted fans, which is a frequency of unforced vibrations.

Advantages of the AirShip Endurance being powered by ducted fan rotors are as follows:
By reducing rotor blade tip losses and directing its thrust towards the back only, the ducted fan is more efficient in producing thrust than a conventional propeller, especially at higher rotational speeds.
By sizing the ductwork appropriately, the aircraft design can adjust the air velocity through the fan to allow it to operate more efficiently at higher air speeds than a propeller would.
For the same static thrust, the aircraft's ducted fan has a smaller diameter than a free propeller.
The aircraft's ducted fan rotors are quieter than propellers; they shield the blade noise, and reduce the tip speed and intensity of the tip vortices both of which contribute to noise production.
Ducted fan rotors can allow for a limited amount of thrust vectoring, something normal propellers are not well suited for. This allows them to be used instead of tilt rotors in some flight management applications.
Ducted fans offer enhanced safety on the ground for humans working near.

The AirShip Endurance design accounts for the following requirements of ducted fan rotors:
Good efficiency that requires very small clearances between the blade tips and the duct.
Represents complex duct design with air accelerator embedded lift rings with high RPM at minimal vibration.

### Fuselage

The aircraft has a fuselage having a longitudinal axis, a left low aspect forward swept fixed wing extending from the fuselage, a right low aspect forward swept fixed wing extending from said fuselage, a tail section extending from the aft portion of the fuselage, a first ducted fan with integrated air accelerator ring embedded stationary from aerial through anterior of the left fuselage, a second ducted fan with integrated air accelerator ring embedded stationary from aerial through anterior to the right fuselage, a third ducted fan with integrated air accelerator ring rotatable and mounted to the aft tail portion, and a solar turbine impeller motor disposed centrally in the fuselage, said motor comprising an electric-drive master impeller contained in a compression chamber having an axis of rotation oriented perpendicular to said longitudinal axis of said fuselage, and said motor powered by electricity from solar film integrated on the surface of said fuselage and wings exterior; and said motor powered by electricity stored from internal rechargeable ultracapacitors mounted inside fuselage, a major air shaft leading from the said master impeller motor chamber to a narrowed minor air shaft that forces super compressed air thrust through the inner lining of each said lateral and aft ducted fans integrated air accelerator rings, an electric micro impeller supercharger motor forcing ingress and egress of super compressed accelerated air thrust through each said ducted fan's integrated air accelerator rings, and wherein said lateral left ducted fan comprises a differential operably connected between left and right counter rotating lateral fan blades, wherein said lateral right ducted fan comprises a differential operably connected between right and left counter rotating fan blades, wherein the most narrowed end of said major and minor air shafts is directly connected to said first lateral ducted fan air accelerator, wherein the most narrowed end of said major and minor air shafts is directly connected to said second lateral ducted fan air accelerator, wherein the most narrowed end of said major and minor air shafts is directly connected to said aft ducted fan air accelerator.

### Alternative Embodiment of Air and Ground Transit UAV

The AirShip Endurance VTOL UAV is scalable to a UAV aircraft with the same design only scaled up to a larger physical foot print with a different propulsion system serving a people and cargo transport mission. This alternative embodiment achieves its power through the placement of two Centrifugal Turbo Shaft type internal combustion engines mounted in-line with respect to the fuselage of the aircraft. The axis of the rotation of the engine's driveshaft is oriented in-line with the longitudinal axis of the fuselage and placed just forward of the lateral ducted fans with integrated air accelerators. These engines use a turbo shaft drivetrain developed for light helicopter applications; provides variable speed capabilities and low fuel consumption.

During flight, the two engine drive trains connect directly to the lateral ducted fan blade assemblies and produce thrust for VTOL operation. Fueled via a combustible fuel tank, a fuel-to-electric generator placed forward in the fuselage generates electric power from the turbo shaft engines to drive the lateral air accelerators rings and aft electric ducted fan with air accelerator ring. During ground transit, the low aspect forward swept wings contract into the fuselage. The in-wheel electric wheel landing gear extends for ground transit and is powered by onboard Lithium-ion batteries.

Flight command and control is achieved through autonomous collision avoidance UAV swarming management system.

### BRIEF DESCRIPTION OF THE DRAWINGS

### AirShip Endurance VTOL UAV and Solar Turbine Clean Tech Propulsion

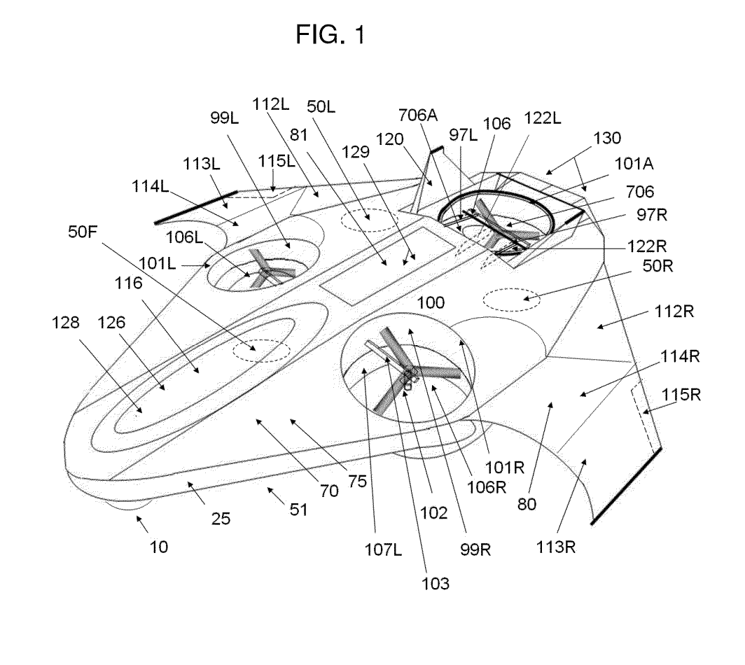

FIG. 1 is a front perspective view of a three ducted fan with integrated air accelerator ring aircraft embodiment of the current invention.

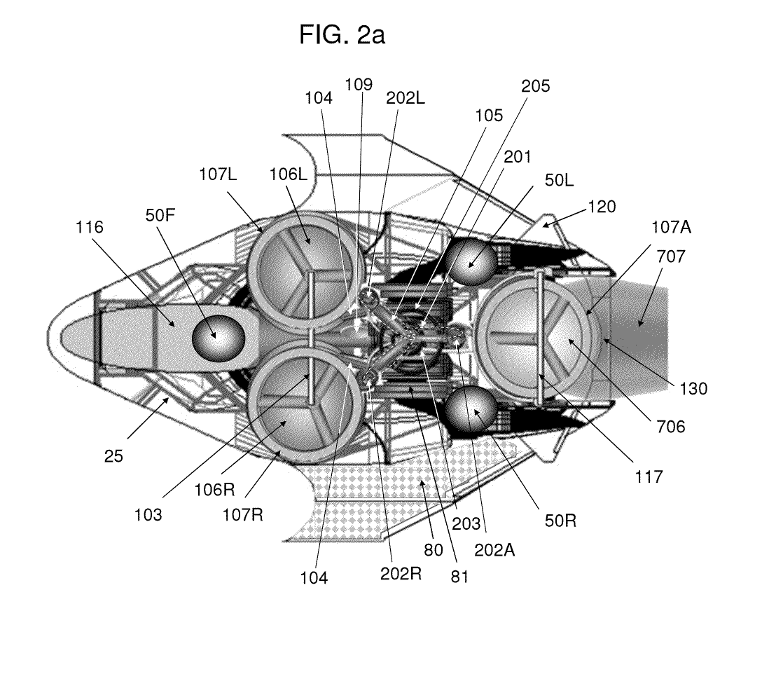

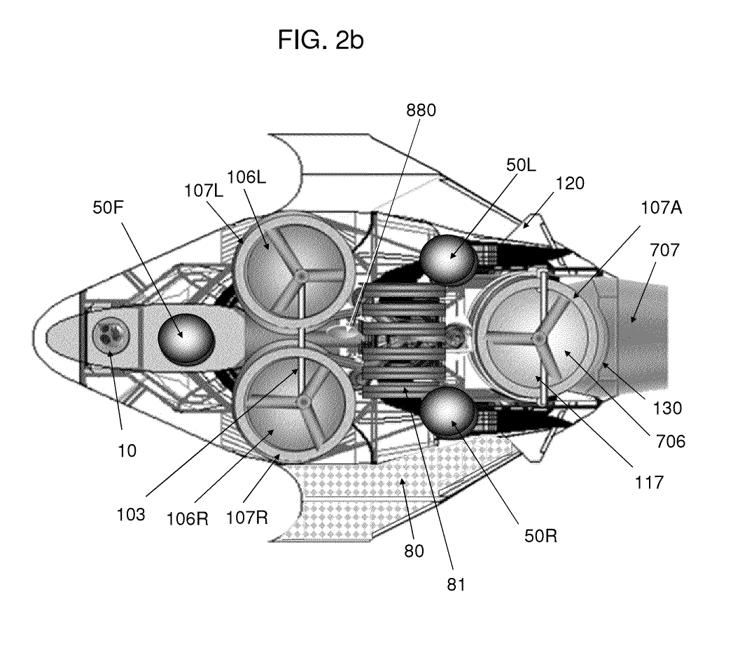

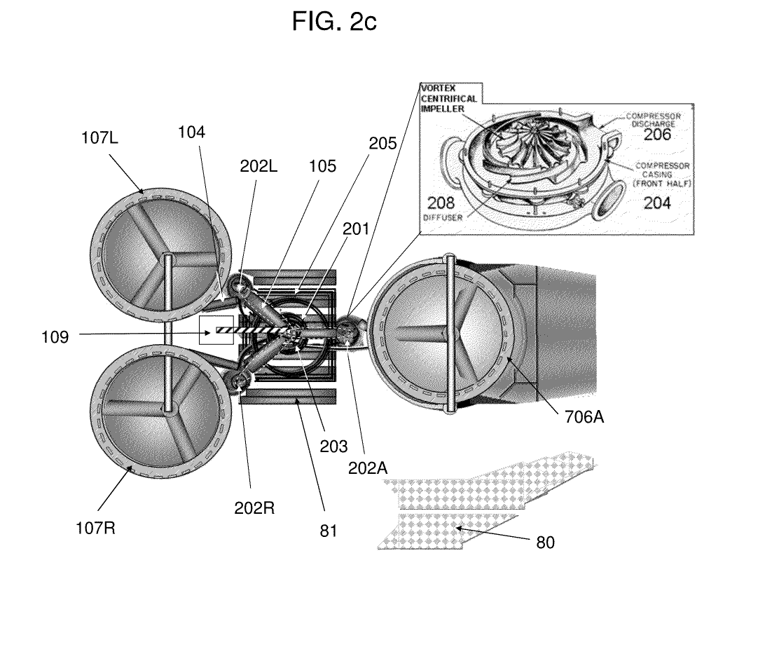

FIG. 2a is a top schematic cross-section view of the aircraft of FIG. 1 showing the Solar Turbine's solar film exterior to the fuselage and low aspect forward swept fixed wings, rechargeable ultracapacitors, one master impeller motor, three micro impeller motors serving the compressed air major shaft connected to the narrowed minor air shaft connected to the narrowed integrated air accelerator nozzle ring for the left and right lateral and aft ducted fans.

FIG. 2b is a bottom schematic cross-sectional view of the aircraft of FIG. 1 showing the ducted fan mounts to the fuselage.

FIG. 2c is a top schematic view of the Solar Turbine with solar film, master impeller motor, three micro supercharger impeller motors, rechargeable ultracapacitors, and narrowing major and minor shaft connections to the ducted fan integrated air accelerator rings.

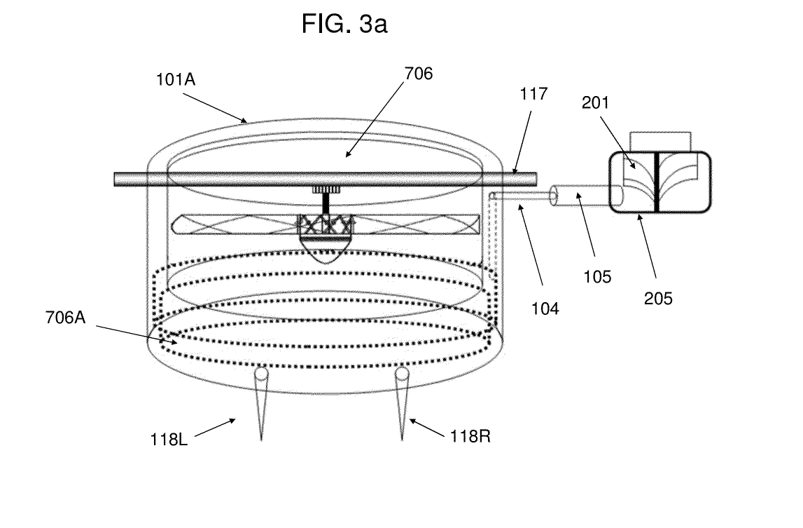

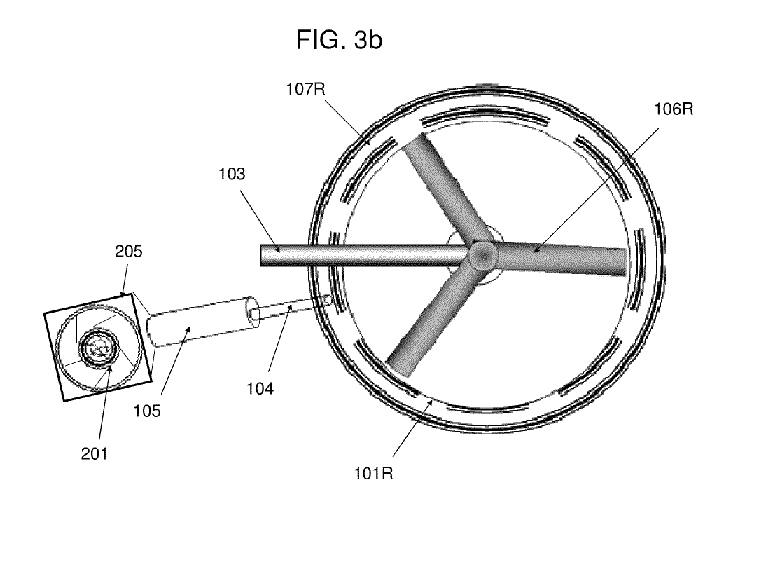

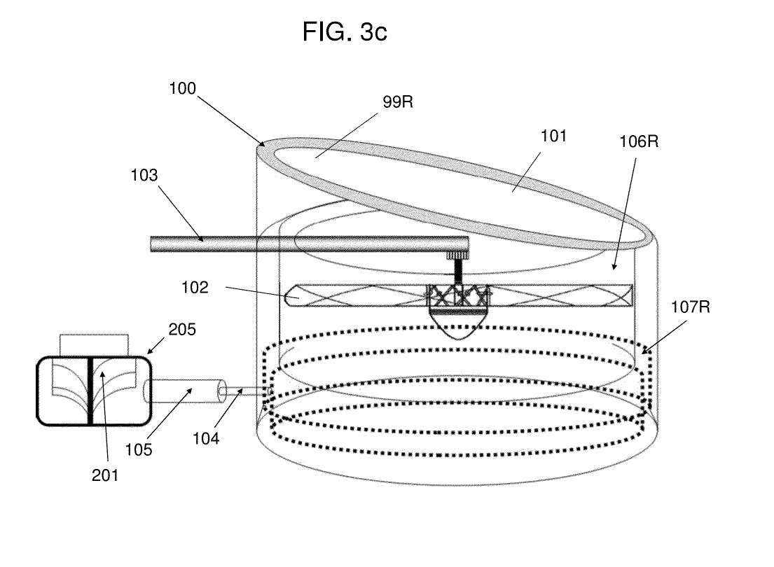

FIG. 3a is a side schematic cross-sectional view of a ducted fan with integrated air accelerator ring, aft ducted fan with cross bar rotatable swivel mount and embedded left and right rudders.

FIG. 3b is a top schematic cross-sectional view of the lateral ducted fan with integrated air accelerator ring of FIG. 3a.

FIG. 3c is a front cross-sectional view of the lateral ducted fan aerial slope with integrated air accelerated ring and embedded ducted fan cross-bar mount of FIG. 3a.

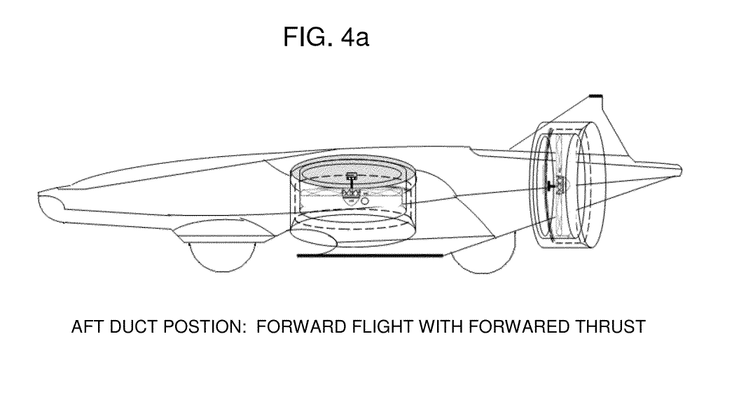

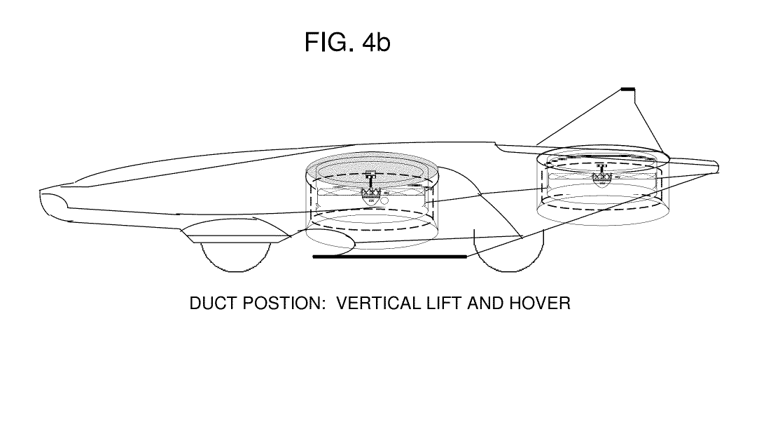

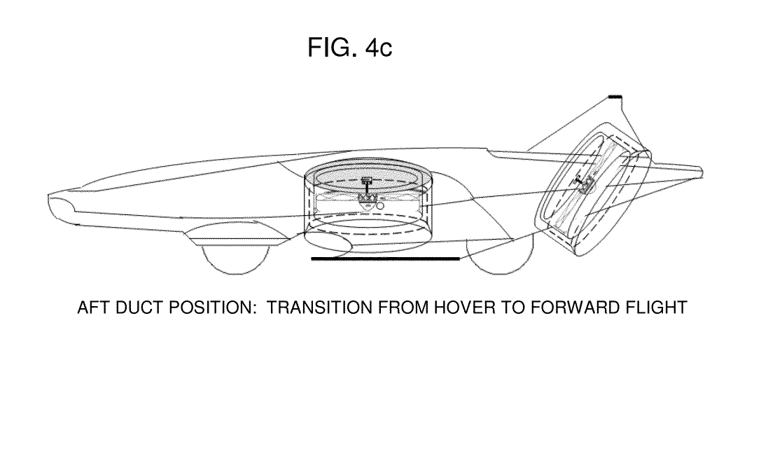

FIG. 4a is a side view of the aircraft of FIG. 1 in forward flight with rear thrust position of aft ducted fan with integrated air accelerator ring.

FIG. 4b is a side view of the aircraft of FIG. 1 in hover position with downward thrust of all three ducted fans with integrated air accelerator rings.

FIG. 4c is a side view of the aircraft of FIG. 1 in vertical take-off to forward flight transition position from 0-degrees to 45-degrees.

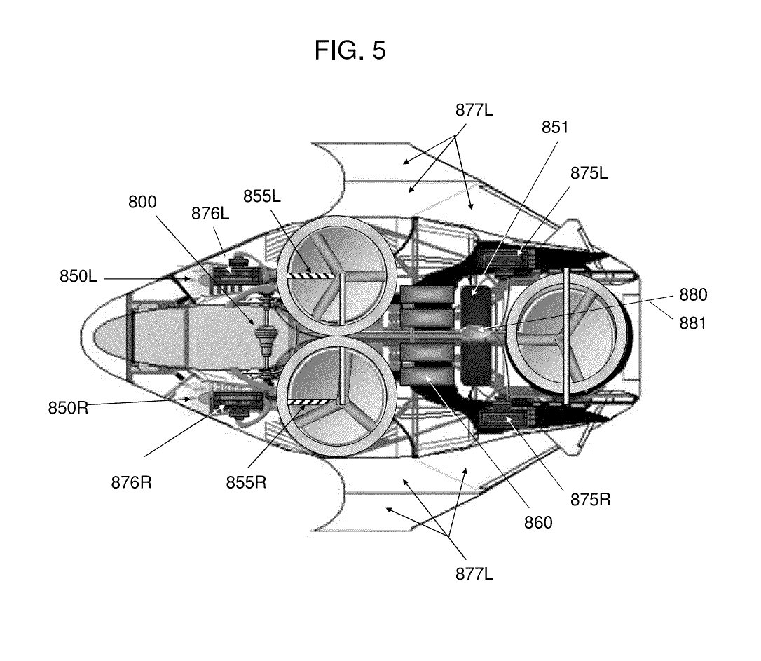

FIG. 5 is a top schematic cross-sectional view of the alternative larger scale embodiment of FIG. 1 for UAV aircraft with a combination air and ground transit mission.

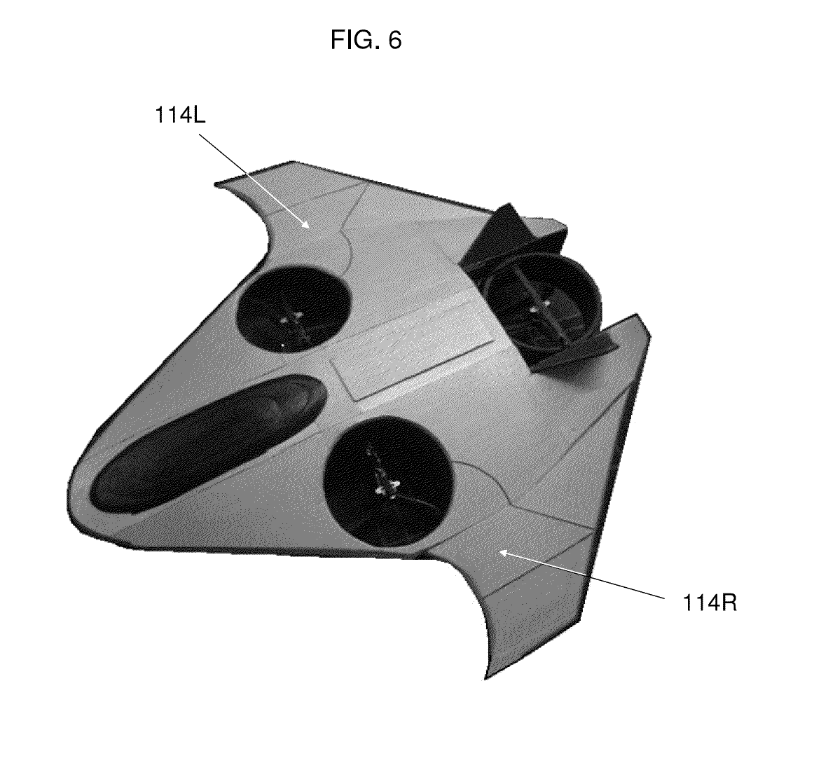

FIG. 6 is a front 3-dimensional perspective view of the unmanned aerial vehicle (UAV) embodiment for original aircraft invention in FIG. 1 and the scaled up front 3-dimensional perspective view of the unmanned aerial vehicle (UAV) in FIG. 5.

### DETAILED DESCRIPTION

### AirShip Endurance VTOL UAV and Solar Turbine Clean Tech Propulsion

As used herein, the following terms should be understood to have the indicated meanings: When an item is introduced by “a” or “an,” it should be understood to mean one or more of that item.
“Comprises” means includes but is not limited to.
“Comprising” means including but not limited to.
“Having” means including but not limited to.
“Including” means including but not limited to.
   VTOL Aircraft with Central Fuselage Mounted Master Impeller Motor and Micro Supercharger Impeller Motors

As shown in FIGS. 1 and 2a, the embodiment of the current invention has two ducted fans with integrated air accelerator rings contained in the mid-section fuselage 100 and one in the aft fuselage 100. This embodiment is a VTOL aircraft with one (1) master impeller motor 201—central fuselage mounted and three (3) micro supercharger impeller motors—one left fuselage mounted 202L, one right fuselage mounted 202R and one aft fuselage mounted 202A. These impeller motors are placed inside the elongated lifting body fuselage 100, which is made of carbon fiber and other lightweight composite materials. This embodiment has a left and right low aspect forward swept fixed wing 113L. 113R mid to aft fuselage 100 with forward flight yaw control winglets 114L, 114R attached on each end of the forward edge of the left and right wing 113L, 113R, two V-tail vertical stabilizers left and right 120L, 120R on the aft fuselage 100, one ducted fan left and right 106L, 106R with integrated air accelerator ring left and right 107L, 107R just forward of the left and right low aspect forward swept fixed wing 113L, 113R. The blades in ducted fans 106L and 106R are mounted to a forward fixed mount bar 103 that connects and helps synchronize the blades 102 of the ducted fan 106L and 106R. In the aft fuselage 100 is a mounted rotatable ducted fan 706 with integrated air accelerator 706A for a total of three (3) ducted fans.

To help envelop the flow of lateral ducted fan air and lift, the low aspect left wing 113L and the low aspect right wing 113R are gently sloped down by 5-degrees with the overall aerodynamic design of the aircraft. The lateral ducted fans 106 and integrated air accelerators have the same design and are referred to as element 106 in the discussion of this embodiment. The lateral ducted fan's 106 leading edge is lower than the trailing edge and serves as a wide aerial air intake scoop during forward flight that rams the air through the ducted fans 106L and 106R. The rear ducted fan 706 is uniquely mounted on an aft rotatable swivel mount 117 and is referred to as element 706 or 706A. Attached to the inner trailing edge of ducted fan 706 are a left rudder 118L and a right rudder 118R to maneuver the aircraft in left or right yaw during forward flight and during yaw on center hover movement left and right, respectively.

The twin V-tail vertical stabilizer 120 and horizontal empennage stabilizer 130 configurations is placed on the aft fuselage 100. The horizontal empennage stabilizer 130 is mounted on top of the rear fuselage 100 with the V-tail vertical stabilizer 120 mounted at 45-degree angles on the aft fuselage 100. Volume coefficients of the empennage were selected according to comparisons with similar aircraft. The AirShip Endurance VTOL UAV has the empennage characteristics of a military jet fighter aircraft.

Empennage geometry characteristics were selected according to the mission specifications, comparisons of similar aircraft, cost, and manufacturability. Each stabilizer surface has a taper ratio of 1.00 to maintain a reasonable aspect ratio and to reduce the overall height of the aircraft. The root and tip chord of each stabilizer surface is chosen thereby simplifying structural mounting to the fuselage 100, fabrication, and thereby reducing cost.

A conventional horizontal empennage stabilizer 130 with an elevator of chord 0.3 cₕₜ is used for longitudinal control. According to similar aircraft, the area of the horizontal stabilizer is more than sufficient for longitudinal control as compared to the wing platform area and the moment arm. The aircraft's OMI (one motor inoperative) criterion determined the size of the V-tail vertical stabilizer 120. Given the thrust 707 produced by the aircraft's aft ducted fan 706 and air accelerator ring 706A and the moment arm of the empennage, the aircraft is directionally stable in flying straight and level when in a glide state. This is the most important driving factor for sizing the V-tail vertical stabilizer 120. After iteration of the stability and control and the weight and balance analyses, resulted in the empennage parameters. The layout and platform geometries of the horizontal empennage stabilizer 130 and V-tail vertical stabilizer 120 are defined.

Solar Turbine Clean Tech Propulsion. The aircraft's ducted fans 106L and 106R are mounted via a fixed forward mount 103 and contains lateral electric fan blades with regenerative drive 102, and integrated air accelerator forced air propulsion inner rings 107L and 107R. The rings are powered by highly efficient and high yield photovoltaic nano-tech-based solar film 80, an electric master impeller motor 201 three micro supercharger impeller motors 202L, 202R, 202A and rechargeable ultracapacitors 81 for electricity storage and reuse. The solar turbine clean tech propulsion system is small, lightweight and delivers an improved power-to-weight ratio. No consumable fuel is used onboard the aircraft, only renewable fuel in the form of electricity from nano-tech based photovoltaic thin solar film 80 that produces electricity to power the ducted fans and integrated air accelerators.

Calculations indicate that the total aircraft weight requirement is achievable to support the desired payload of ultracapacitors 81, a nanotechnology micron layers of solar film 80, a carbon fiber substrate fuselage 100, surface printed electro-magnetic interference (EMI) layer 70, and internal printed circuitry electronics 75.

The Solar Turbine's master impeller motor 201 is mounted centrally internal and perpendicular to the fuselage 100 and is contained within a pressurized impeller air reservoir chamber 205 that sucks in external air, compresses the air and ports the compressed air through a series of concentric major air shafts 105 and narrowed to minor air shafts 104 that accelerate the air through the narrowed integrated inner rings 107L, 107L, and 706A of all three (3) ducted fans 106L, 106R, and 706. The master impeller motor's 201 air pressure reservoir chamber 205 sucks in external air from the aircraft's wide lateral ducted fan aerial scoop intakes 99L and 99R. The master impeller motor 201 is located at the aircraft centerline, while still maintaining the required equal distance from the two lateral ducted air turbines 106L and 106R and aft air ducted turbine 706. The master impeller motor 201 is mounted downward into the air pressure reservoir chamber 205 to force the air equally to all three integrated air accelerator rings in the cylindrical duct 101 housing.

To move massive amounts of air, the forced air is pushed at high velocity using the turbo style blades of the master impeller motor 201. External air is sucked in through the aircraft's lateral ducted fan aerial air intake scoops 99L and 99R. Then the air is forced at high velocity through major 105 and minor 104 narrowing air shafts and finally thrust through the aircraft's three narrowed shaft integrated air accelerator inner rings 107L, 107R and 706.

The master impeller motor 201 configurations assume a central primary motor to run the aircraft's air accelerator rings 107L, 107R and 706. Even with a failed master impeller motor, the aircraft can run on direct solar power or electricity stored in the ultracapacitors. The solar turbine clean tech propulsion provides for failsafe architecture should any of the impeller motors fail. This redundancy approach provides for high availability and return to base preventing the aircraft from having loss of power. The master impeller motor 201 is spun up to 4,000 RPM forcing air from the lateral ducted fan top air dam scoops 99L and 99R through the narrowing major air shafts 105 and minor air shafts 104, and finally into the narrowed shaft of the ducted air accelerator rings 107L, 107R and 706A; thus, creating cyclonic lift. Cyclonic lift forms when the energy released by the forced air from the integrated air accelerator rings 107L, 107R and 706A causes a positive feedback loop under the aircraft. The ducted fan shape enables the cyclonic lift as an area of closed, circular fluid air motion that is counter rotating in the lateral ducted fans 106L and 106R while being independent in the aft ducted fan 706. When executed, it enables vertical take-off and landing (VTOL), but also allows for aircraft flight maneuvering.

To dramatically increase the solar turbine VTOL operation by a significantly large thrust factor, the aircraft's integrated air accelerator rings 107L, 107R, and 706A propulsion utilizes a centerline-based, independent brushless electric motor 109 that connects three clutch able pulley drive chains 203 that are each attached to three micro impeller motors 202L, 202R, 202A that force compressed air through three major air shafts 105 that narrow to three minor air shafts 104, and then narrow to the three integrated air accelerator rings 107L, 107R, and 706A in the fuselage 100 ducts 101L, 101R and 101A. This added air compressor configuration is supported by three Vortech supercharger impeller motors that dramatically accelerate the air flow into the ducted fan integrated air accelerator rings 107L, 107R, and 706A during the aircraft's VTOL operations. This architecture establishes an auxiliary belt (clutch able pulley drive chain 203) from the brushless electric motor 109 to each vortex Supercharger impeller motors 202L, 202R, 202A and each vortex supercharger produces just-in-time added horsepower with air thrust propulsion. The Vortex compressor micro impellers 202L, 202R, 202A are attached to a clutch able pulley 203 that is enclosed in an impeller air reservoir chamber 205 that is attached directly to the airflow of the integrated air accelerator rings 107L, 107R, and 706A. The Vortex supercharger compressor micro impeller motors 202L 202R, and 202A suck in air from the lateral ducted fan's top air dam scoops 99L and 99R. The pulley sizing vary according to the speed or thrust required to operate the aircraft with all three integrated air accelerator rings 107L, 107R, and 706A engaged at VTOL, or during full out, top speed fixed wing forward flight with only the aft ducted fan 706 and integrated air accelerator ring engaged.

For short time durations and for maximum power, the Vortech Supercharger provides high forced air thrust to the integrated air accelerator rings 107L, 107R, 706A. This supercharged forced air is used to maximize power for the aircraft's vertical take off and landing maneuvers and for when high thrust 707 is required to meet flight collision avoidance and/or high speed velocity demands.

The characteristics of the Vortech centrifugal micro impeller motor compressors 202L, 202R, 202A make it the most effective supercharger component to augment power to the Solar Turbine Air Accelerator Clean Tech Propulsion. This type of compressor operates most effectively at high speeds, and has the ability to compress a large volume of air at low pressure. Because the centrifugal compressors 202L, 202R, 202A. run at high speeds, their size is relatively small and their weight is light. It also has minimum moving parts, and the problems of lubrication and maintenance are thereby minimized. The vortex centrifugal compressor 202L, 202R, 202A consists of three basic elements—the micro impeller 202 the diffuser 203, and the casing 204. Air enters the micro impeller 202 at the center and is discharged 206 radially at the ends of the micro impeller blades 207 with high velocity. The diffuser 203 converts this energy to pressure energy. The casing 204 collects the air under pressure for delivery to the integrated air accelerator rings 107L, 107R, and 706A.

To add air thrust 707 during VTOL operations, the micro impeller supercharger 202 must spin rapidly—more rapidly than the Air Accelerator's master impeller motor 201. Making the drive gear larger than the compressor gear causes the compressor to spin faster. The Air Accelerator master impeller motor 201 spins at 4,000 rotations per minute (RPM), but the three supercharger micro impeller motors 202L, 202R, and 202A can spin at speeds as high as 50,000 to 65,000 RPM.

A compressor spinning at 50,000 RPM translates to a boost of about six to nine pounds per square inch (psi). That's six to nine additional psi over the atmospheric pressure at a particular elevation. Atmospheric pressure at sea level is 14.7 psi, so a typical boost from a supercharger places about 50 percent more air into the overall Solar Turbine Clean Tech Air Accelerator Propulsion System.

As the air is compressed, it gets hotter, which means that it loses its density and cannot expand as much during the power boost. For the supercharger to work at peak efficiency, the compressed air exiting the discharge unit 206 and entering the integrated air accelerator rings 107L, 107R and 706A is cooled as it enters the ring (induction) system. An air-intercooler of major air shafts 105 narrowing to minor air shafts 104 is responsible for this cooling process and it works just like a radiator, with cooler air sent through a system of narrowing pipes or tubes. As the hot air exiting the supercharger micro impeller 202 encounters the integrated air accelerator (induction) system air thrust is cooled. The reduction in air temperature increases the density of the air, which makes for a denser charge entering the air accelerator rings and creating thrust 707 just as the forced air flows through the ducted rings 107L, 107R and 706A.

The aircraft's rechargeable ultracapacitors 81 are used to store electricity generated by the photovoltaic nano-tech-based solar film 80 and the regenerative lateral ducted fans 106L and 106R. The ultracapacitors are similar to batteries, but much lighter. They store electricity very quickly, and dissipate that energy very slowly.

The specific propulsion that the aircraft will use is the Solar Turbine Air Accelerator Clean Tech Propulsion. This propulsion system is in the class of aircraft called powered lift. The aircraft is a heavier-than-air aircraft capable of vertical takeoff and vertical landing. The aircraft has two executions for lift. It can use its mounted ducted fans 106L, 106R and 706 for lift and forward flight, but the ducted fan's noise factor may exceed some mission requirements. Should the mission require less noise, the ducted fans 106L, 106R and 706 can be powered down and the integrated air accelerators 107L, 107R and 706 enabled by powering up which generates much less noise. This muted noise gives the aircraft a stealth character where the aircraft is not heard due to engaging only the integrated air accelerator rings 107L, 107R and 706A. This approach is especially good for low speed flight that depends principally on air accelerator turbine-driven lift that produces master impeller motor 201 thrust 707 for lift during a flight regime. This propulsion is performed on all non-rotating ducted fan 106L, 106R and 706 airfoils that deliver thrust 707 for fixed wing lift during horizontal flight.

The Solar Turbine delivers persistent flight endurance by enabling the aircraft to fly on solar power generation while recharging ultracapacitors during daylight hours and fly only on the ultracapacitors at night. As the day's sunlight returns, the cycle repeats itself providing for long flight performance for months without power exhaustion. The aircraft is based on a constant recharging electric architecture with the UAV's fuselage and low aspect forward mounted wings that are externally covered with a solar film array that recharges internal ultracapacitors. With the AirShip Endurance VTOL UAV's ultralite weight and aircraft glide loitering flight patterns, the aircraft flight endurance is designed to fly aloft until a scheduled maintenance, repair & overhaul (MRO) point. The aircraft's MRO is within 30 to 90 days of flying time, depending on the weather conditions.

Ducted Fan Mechanics. The air flow fluid dynamics and mechanical components inside the ducted fans are the same including the electric motor blades with regenerative drive 102 mounted within the counter-rotating lateral ducted fans 106L and 106R and the aft ducted fan 706A. For the lateral ducted fans 106L and 106R, one forward ducted fan mount 103 extends through the fuselage 100 to connect the electric lateral fan blades with regenerative drive 102 at either end. The electric blades 102 are centrally mounted within the fuselage 100 cylindrical shroud or duct 101 and positioned centrally within the left lateral duct 101L and right lateral duct 101R. The fan blades 102 are mounted in the upper central portion of the ducts, but below the lateral ducted fan top air dam scoop 99. The aft ducted fan 706 attaches its electric fan blades on an aft ducted fan cross bar swivel mount 117 raised above the top of the aft ducted fan 706. A redundant ducted fan aft actuator arm left 97L and aft ducted fan actuator arm right 97R pull back to raise the aft ducted fan 706 for forward flight (from 0 degrees hover to +90-degrees forward flight) and to push back the actuator arms 97L and 97R from 90-degrees forward flight to 0-degrees hover to −45-degrees reverse backup. FIGS. 4a 4b 4c illustrate the lateral ducted fans as fixed while delivering downward thrust 707 (0-degrees) during takeoff, hover, transition to forward flight and during forward flight. The aft ducted fan 706 creates the thrust for takeoff in either vertical or forward flight. FIGS. 4a, 4b, and 4c illustrate various rotational positions of the aft ducted fan 706 with integrated air accelerator 706A and how it affects take-off, flight, hover and reverse (backup).

All three ducted fans with integrated air accelerators rings 107L, 107R and 706A are made of carbon fiber. The air accelerator rings 107L, 107R, and 706A are an integrated molded part of the ducts 101L, 101R, 101A and are located one quarter from the anterior portion of all three ducts. The ducted fans with molded air accelerator rings are designed for optimal thrust 707 propulsion. The ducted fans are electric fans and the air accelerator ring thrust 707 is driven by the Solar Turbine Clean Tech Propulsion System.

FIG. 3a and FIG. 3b illustrate the aerodynamic shape of the aft ducted fan 706A with the bottom of the ducted fan with attached left rudder 122L and right rudder 122R. FIG. 3b details the aerial view of a lateral ducted fan 106L and 106R. FIG. 3c shows the cross-section of a lateral ducted fan 106L and 106R with integrated air accelerator rings 107L and 107R and the forward ducted fan mount 103 for the lateral electric fan blades 102.

V-Tail Vertical Stabilizer. The most noticeable impact that stability and control has on the design is the relatively large vertical V-Tail and horizontal empennage of the AirShip Endurance VTOL UAV. This is a result of sizing the rudders to maintain control during OMI (one motor inoperative) flight at minimum control speed. Stability and control also affects the wing placement, the air accelerator rings 107L, 107R and 706A, and the master impeller motor 201 location. The size of the horizontal empennage stabilizer 130 is determined by the static margin requirement of 10%. The V-tail vertical stabilizer 120 is on each side and at the end of the aft fuselage 100 to minimize or eliminate the yaw and roll oscillations and to reduce the drag off the aft end of the lifting body fuselage 100. A left rudder 122L and right rudder 122R is attached to the end of the aft ducted fan 706 and provides yaw control.

Hover Control. The aircraft's three air accelerator rings 107L, 107R and 706A supporting three ducted fans (two laterals 106L 106R and one aft 706) provide the configuration to ensure the aircraft's hover stability. The aircraft is able to hover by aerodynamic means. The aircraft's ducted fans produce forced air, and as it does so, it generates an aerodynamic propulsive lift force. The aircraft pulls itself upward to a hover position because of the aerodynamic force generated by its ducted fans with integrated air accelerator rings 107L, 107R and 706A as they slice through and displace air.

Avionics Bay. The aircraft avionics bay 128 for storing the aircraft's computer, gyroscopic equipment 880, transmitter, receiver, etc. may be located under the forward canopy 116 of the aircraft. The avionics bay 128 may house the flight computers and gyroscopes 880 which handle guidance, navigation and control. A second maintenance bay 129 may be located mid-fuselage and is accessible between the two lateral ducted fans 106L, 106R and just in front of the aft ducted fan 706. A nanotechnology based air sniff filter 126 with electronics connected in the avionics bay may be attached to or incorporated within the surface of the canopy 116.

Center of Aircraft. The low aspect forward swept fixed wings 113L, 113R are attached to the bottom of the fuselage 100 below the payload floor of the aircraft. The aft ducted fan can serve as a speed brake by reversing the angle of attack of the aft ducted fan 706 and actually reverse (backup) the flight of the aircraft. This speed brake maneuver allows the aircraft to slow while in forward flight or stop to a hover. It can also cause the aircraft to fly backwards with the aft ducted fan 706 directing the course of travel. The low aspect forward swept fixed wings 113L and 113R may include winglets 114 to help reduce drag and thereby increase speed and lift. Ailerons left and right 115L, 115R help control roll while in forward flight Aerial and anterior Clamshell Flaps 112L and 112R help reduce landing speed and help the aircraft move into transitional speed while switching from horizontal to vertical and/or back to horizontal flight. Lateral ducted fans 106L and 106R serve as pass-through fuselage surface openings resulting in less drag upon vertical take-off and landing.

Clamshell Flaps. The UAV uses clamshell flaps both aerial and anterior 112L and 112R in combination with the aircraft gyro and ducted fan ports for aerodynamic advantage and agility. The clamshell flaps advantages include directed thrust. Individual controlled clamshell flaps serve to replace traditional flaps, rudders and stabilizers. The clamshell flaps serve as air brakes while in forward flight mode, and synchronized gyros compensate for flight stability loss. The two independent clamshell flap system reduces weight, increases maneuverability and simplifies the UAV design. As a result, the clamshell flaps provide for aerodynamic flight combinations including barrel rolls, dives, corkscrews, crabbing, inverted loops, air braking and other maneuvers.

Landing Gear. The aircraft is designed with landing gear to withstand the impact of a fully loaded aircraft. For landing gear, there are three landing gear dome bumpers 50F, 50L and 50R used for protecting the aircraft's aerodynamic undercarriage 51 surfaces and equipment. The landing gear dome bumpers isolate the ducted fans 106L, 106R and 706 with integrated air accelerator rings 107L, 107R and 706A and surveillance camera turret apparatus 10 from impact and vibrations from VTOL operations. The landing gear dome bumpers 50 are medium-soft, non-marking polyurethane-rubber material with Durometer hardness of 70 Scale OO.

While landing or taking off, this cushioned landing gear design allows a softer landing to prevent fuselage 100 and airframe 25 damage. The landing gear dome bumpers are designed to withstand the load of the AirShip Endurance VTOL UAV. This will ensure structural integrity for a fully loaded AirShip Endurance VTOL UAV aircraft landing. The landing gear dome bumpers 50F, 50L and 50R will allow landings on hard surfaces, unpaved or soft fields, and water. The landing gear domes are wide enough in diameter and height that aircraft clearance is maintained from ground surfaces. With this, the landing gear is required to soften a high descent rate landing.

### Description of Further Alternative Embodiments

Air and Ground Transit UAV. Initially, AirShip Endurance VTOL UAV was being developed for the military; however, there is an additional market calling. An in-depth analysis of the vehicle's vertical lift transport market was performed based on global market trends for targeted augmentation of light aircraft, helicopters, and ground transport. The analysis of the industry's competitive structure and market segments has indicated the existence of an under-satisfied and sufficiently large target market to warrant exploitation by multi-functional air/vehicles. For the most part, the existing market delivery structure offers transportation that is efficient but separate. Ground transport vehicles travel roads and highways while aircraft fly the skies. None can do both and therein lies the gap and the AirShip's advantage to introducing military and commercial vertical takeoff and landing (VTOL) unmanned aerial vehicle (UAV) technology.

Once the gap in the existing delivery structure was identified, market research was undertaken to identify specific market segment associations for standard metropolitan statistical areas of people and business organizations that would be potential customers. For business and government, the organizations with a vested stake in AirShip Endurance VTOL UAV development are those that currently use helicopters, light commuter aircraft or are in the transportation service market. They are companies such as executive helicopter services, news media, hospital emergency flight rescue services, security operations, law enforcement and government/military mission branches.

The AirShip Endurance VTOL UAV is scalable to a UAV aircraft with the same design only scaled up to a larger physical foot print with a different propulsion system serving a people and cargo transport mission. This alternative embodiment achieves its power through the placement of two Centrifugal Turbo Shaft type internal combustion engines 850L, 850R mounted in-line with respect to the fuselage 100 of the aircraft. The axis of the rotation of the engine's driveshaft 850L, 850R is oriented in-line with the longitudinal axis of the fuselage 100 placed just forward of the lateral ducted fans 106L, 106R with integrated air accelerators 107L, 107R. These engines use turbo shaft drive trains 855L, 855R developed for light helicopter applications; provides variable speed capabilities and low fuel consumption.

During flight, the two engine drive trains 855L, 855R connect directly to the lateral ducted fan blade with regenerative drive 102 assemblies and produce thrust 707 for VTOL operation. Fueled via a combustible fuel tank 851, a fuel-to-electric generator 800 placed forward in the fuselage 100 generates electric power from the turbo shaft engines 850L, 850R to drive the lateral air accelerators rings 107L, 107R and aft electric ducted fan 706 with air accelerator ring 706A. During ground transit, the low aspect forward swept wings 877L, 877R contract into the mid to lower fuselage 100.

The in-wheel electric wheel landing gear 875L, 875R, 876L, 876R extends for ground transit and is powered by onboard Lithium-ion batteries 860.

Flight command and control is achieved through autonomous collision avoidance UAV swarming management system.

1. An aircraft comprising:
a fuselage having a longitudinal axis;
a left low aspect forward swept wing mounted well back on said fuselage;
a right low aspect forward swept wing mounted well back on said fuselage;
a tail section extending from a aft portion of said fuselage;
a first electric regenerative ducted fan with integrated air accelerator ring embedded stationary from aerial through anterior to said left fuselage;
a second electric regenerative ducted fan with integrated air accelerator ring embedded stationary from aerial through anterior to said right fuselage;
a third electric ducted fan with integrated air accelerator ring rotatable and mounted to the aft tail swivel cross bar, and
a solar turbine powered master impeller motor disposed centrally in said fuselage, said motor comprising an electric-drive impeller contained in a compression chamber having an axis of rotation oriented perpendicular to said longitudinal axis of said fuselage, and said motor powered by electricity from solar film (thin film) integrated on the entire upper and lower surface of said fuselage and exterior wings; and said master impeller motor alternatively powered by electricity storage from internal rechargeable ultracapacitors mounted inside fuselage
a major air shaft leading from the said master impeller motor chamber to a narrowed minor air shaft that forces super compressed air thrust through the narrowed air shaft inner lining of each said lateral and aft ducted integrated air accelerator rings;
a belt-driven electric micro impeller supercharger motor forcing ingress and egress of super compressed accelerated air thrust through each said ducted integrated air accelerator ring, and
wherein said lateral left ducted fan comprises a differential operable connected between left and right counter rotating lateral fan blades;
wherein said lateral right ducted fan comprises a differential operable connected between right and left counter rotating fan blades;
wherein the most narrowed end of said major and minor air shafts is directly connected to said first lateral narrowed ducted air accelerator ring;
wherein the most narrowed end of said major and minor air shafts is directly connected to said second lateral narrowed ducted air accelerator ring;
wherein the most narrowed end of said major and minor air shafts is directly connected to said aft narrowed ducted air accelerator ring.

2. The aircraft of claim 1 wherein said solar turbine electric motor comprises a plurality of master impeller motor and micro supercharger impeller motors connected to said electric ducted fans with integrated air accelerator rings.

3. The aircraft of claim 2 wherein said plurality of motors comprises a first motor type and a second motor type.

4. The aircraft of claim 3 wherein said first motor type comprises a master electric impeller motor and said second motor type comprises three micro supercharger impeller motors.

5. The aircraft of claim 4 wherein said solar turbine electric motor has a first mode in which said electric motor drives said lateral and aft ducted fans with integrated air accelerator rings, and a second mode in which said solar turbine electric motor serves as a generator driven by said first mode and charges ultracapacitors electrically connected to said electric motor.

6. The aircraft of claim 5 wherein said solar turbine electric motor operates in said first mode during daylight take-offs, flight and landings; and said solar turbine electric motor operates in said second mode during nighttime take-offs, flight and landings.

7. The aircraft of claim 1 wherein each of said lateral and aft ducted fans with integrated air accelerator rings comprises an aerodynamic lifting intake portion having a top portion that serves as air ingress (entrance), and wherein said bottom portion serves as an air egress (departure).

8. The aircraft of claim 1 wherein the fuselage and low aspect forward swept retractable wings are scaled larger to carry people and/or cargo that serve as a combination air transit with alternative turbo shaft engine propulsion and ground transit with in-wheel electric wheel drive.
